(19) United States
(12) Patent Application Publication
(10) Pub. No.: US 2018/0148120 A1
(43) Pub. Date: May 31, 2018

(54) BALANCING VEHICLE

(71) Applicant: Better Wheels, LLC., Las Vegas, NV (US)

(72) Inventors: Zhijun YANG, Shenzhen (CN); Hovik John Soibatian, Whittier, CA (US)

(73) Assignee: Better Wheels, LLC., Las Vegas, NV (US)

(21) Appl. No.: 15/398,710

(22) Filed: Jan. 4, 2017

Related U.S. Application Data
(63) Continuation-in-part of application No. 15/376,683, filed on Dec. 13, 2016.
Application No. 15/376,683 is a continuation-in-part of application No. 15/361,084, filed on Nov. 25, 2016.

(51) Int. Cl. B62K 11/00; B62K 23/08; B62J 25/00; B62M 7/12

(52) U.S. Cl. CPC B62K 11/007; B62K 23/08; B62K 2207/00; B62M 7/12; B62K 2202/00; B62J 25/00

(57) ABSTRACT

The present disclosure provides a balancing vehicle. The balancing vehicle comprises a baseplate, a pedal assembly, a detecting module, a wheel assembly, and a control system. The pedal assembly is disposed above and pivotally connected to the baseplate. The detecting module is disposed between the baseplate and the pedal assembly to detect a motion of the pedal assembly relative to the baseplate. The wheel assembly is rotatably coupled to the baseplate. The control system is attached to the baseplate and electronically connected to the detecting module and mechanically coupled to the wheel assembly so as to control the wheel assembly based on the motion of the pedal assembly detected by the detecting module.

### CROSS REFERENCE TO RELATED APPLICATIONS

This application is a Continuation-In-Part application of U.S. non-provisional application Ser. No. 15/376,683, and titled “Pedal Connection Mechanism and Electric Balancing Vehicle Using the Same”, filed in the United States Patent and Trademark Office on Dec. 13, 2016, which is based on and claims priority to Chinese Patent Application No. 201610077468.X, filed on Feb. 3, 2016, the entire contents of which are incorporated herein by reference. Further, this application is also a Continuation-In-Part application of U.S. non-provisional application Ser. No. 15/361,084, and titled “Pedal Connection Mechanism and Electric Balancing Vehicle Using the Same”, filed in the United States Patent and Trademark Office on Nov. 25, 2016, which is based on and claims priority to Chinese Patent Application No. 201620112263.6, filed on Feb. 3, 2016 the entire contents of which are incorporated herein by reference.

### TECHNICAL FIELD

The present disclosure relates to a technical field of a transportation vehicle, in particular, to a balancing vehicle.

### BACKGROUND

An electric balancing scooter is also known as a somatosensory scooter, Segway, or the like. It is a popular transportation vehicle among modern people and can meet people's requirements on leisure, entertainment, and environmental friendliness. On the basis of the principle of “dynamic stability”, the electric balancing vehicle determines the vehicle's position and condition by using a gyroscope and an acceleration sensor, and calculates appropriate instructions through a sophisticated, high-speed central microprocessor, and then drives motor to make adjustments correspondingly so as to keep balance of the system.

A balancing vehicle equipped with a steering rod is available on the market. In use, the user controls the direction of movement of the balancing vehicle by adjusting the steering rod. It is complicated and relatively difficult to complete the operation of adjusting the steering rod. In addition, it is easy to cause wear between the steering rod and controlling connection parts, leading to the failure of the balancing vehicle. Furthermore, since the user needs to hold the steering rod without stretching and other movements, the fun of playing is reduced.

The Chinese Patent Application No. 201520567850.X discloses a double-wheeled balancing vehicle, which does not need the steering rod to adjust the vehicle's motion status. However, the left and right pedals of this two-wheeled balancing vehicle are connected by an intermediate shaft. In use, the whole weight of a human body is born by the intermediate shaft. The twisting of the body of the balancing vehicle may easily cause damage, even crack, to the intermediate shaft. The balancing vehicle with this structure is prone to failure and has low stability. The reliability and security of this balancing vehicle also need to be improved. In addition, the design of the balancing vehicle with the intermediate shaft has a low flexibility and a large reaction error.

### SUMMARY

The above-identified shortcomings as well as other shortcomings are addressed by the present disclosure, which will be understood by reading and studying the following specification.

In the first aspect, the present disclosure provides a balancing vehicle. The balancing vehicle comprises a baseplate, a pedal assembly, a detecting module, a wheel assembly, and a control system. The pedal assembly is disposed above the baseplate and pivotally connected thereto. The detecting module is attached to the pedal assembly to detect motion status of the pedal assembly. The wheel assembly is rotatably connected to the baseplate. The control system is attached to the baseplate. The control system is electronically connected to the detecting module and mechanically coupled to the wheel assembly to control the wheel assembly based on the motion of the pedal assembly detected by the detecting module.

In some embodiments, the baseplate may include a first section, a second section opposite to the first section.

In some embodiments, the first and second sections may be formed separately.

In some embodiments, the baseplate may include at least two first supports on the first section and at least two second supports on the second section.

In some embodiments, the pedal assembly may include a first pedal pivotally connected to the at least two first supports and a second pedal pivotally connected to the at least two second supports.

In some embodiments, the first pedal may be connected to one of the at least two first supports though one pivot shaft and to another of the at least two first supports through another pivot shaft. The second pedal may be connected to one of the at least two second supports though one pivot shaft and to another of the at least two second supports through another pivot shaft.

In some embodiments, the first pedal may be connected to the at least two first supports though one pivot shaft, and the second pedal may be connected to the at least two second supports though one pivot shaft.

In some embodiments, the at least two first supports and the at least two second supports may be arranged in a line along a length direction of the baseplate.

In some embodiments, the at least two first supports may be upwardly protruded from the first section and spaced away from each other and the at least two second supports may be upwardly protruded from the second section and spaced away from each other.

In some embodiments, the baseplate may include a first section, a second section opposite to the first section, and a third section between the first section and the second section.

In some embodiments, the first, second, and third sections may be formed separately.

In some embodiments, the baseplate may include a first supports on the first section, a second supports on the second section, and a third support on the third section.

In some embodiments, the pedal assembly may include a first pedal pivotally connected to the first support and the third support and a second pedal pivotally connected to the second support and the third support.

In some embodiments, the first pedal may be connected to the first support though one pivot shaft and to the third support through another pivot shaft. The second pedal may be connected to the second support though one pivot shaft and to the third support through another pivot shaft.

In some embodiments, the first pedal may be connected to the first support and the third support though one pivot shaft, and the second pedal may be connected to the second support and the third support though one pivot shaft.

In some embodiments, the first, second, and third supports may be arranged in a line along a length direction of the baseplate.

In some embodiments, the balancing vehicle may further comprise at least two first resilient members and at least two second resilient members. The at least two first resilient members each may be abutted against the first pedal and the first section. The at least two second resilient members each may be abutted against the second pedal and the second section.

In some embodiments, one end of the resilient member may be abutted against the bottom surface of the pedal, and the other end of the resilient member may be abutted against the top surface of the baseplate.

In some embodiments, the at least two first resilient members may be located on each side of a first pivot axis about which the first pedal pivots.

In some embodiments, the at least two second resilient members may be located on each side of a second pivot axis about which the second pedal pivots.

In some embodiments, the resilient member may be a spring or a rubber block.

In some embodiments, the first pivot axis and the second pivot axis are collinear. In some embodiments, the first pivot axis and the second pivot axis are not collinear.

In some embodiments, the detecting module may comprise a first detector and a second detector. The first detector may be disposed between the first pedal and the first section to detect motion status of the first pedal. The second detector may be disposed between the second pedal and the second section to detect motion status of the second pedal.

In some embodiments, the first detector may include a gyroscope and an acceleration sensor.

In some embodiments, the second detector may include a gyroscope and an acceleration sensor.

In some embodiments, the control system may include a motor, a controller, and a battery. The motor may be attached to the baseplate and mechanically coupled to the wheel assembly to provide a driving force thereto. The controller may be attached to the baseplate and electronically connected to the detecting module and the motor to control the motor based on the motion of the pedal assembly detected by the detecting module. The battery may be attached to the baseplate and electrically connected to the motor, the detecting module, and the controller.

In the second aspect, the present disclosure provides a balancing vehicle. The balancing vehicle comprises a baseplate, a first pedal, a second pedal, a first detector, a second detector, a first wheel, a second wheel, a first motor, a second motor, and a control system. The baseplate includes a first section and a second section. The first pedal is disposed above and pivotally connected to the first section. The second pedal is disposed above and pivotally connected to the second section. The first detector is attached to the first pedal to detect a motion status of the first pedal. The second detector is attached to the second pedal to detect a motion status of the second pedal. The first wheel is rotatably mounted to the first section. The second wheel is rotatably mounted to the second section. The first motor is mounted to the first section and mechanically coupled to the first wheel to provide a driving force to the first wheel. The second motor is mounted to the second section and mechanically coupled to the second wheel to provide a driving force to the second wheel. The control system is attached to the baseplate and electronically connected to the first detector, the second detector, the first motor, and the second motor. The control system is configured to control the first motor and the second motor based on the motion status of the first pedal that is detected by the first detector and the motion status of the second pedal that is detected by the second detector.

In some embodiments, the balancing vehicle may further comprise a battery. The battery may be attached to the baseplate and electrically connected to the control system, the first detector, the second detector, the left motor, and the right motor to provide electricity to them.

In some embodiments, the first section may be provided with two first supports protruded from the first section and spaced away from each other. The second section may be provided with two second supports protruded from the second section and spaced away from each other.

In some embodiments, the first pedal pivotally may be connected to the two first supports such that the first pedal is pivotable about a first pivot axis, and the second pedal may be pivotally connected to the two second supports such that the second pedal is pivotable about a second pivot axis.

In some embodiments, the two first supports may be upwardly protruded from the first section and spaced away from each other and the two second supports may be upwardly protruded from the second section and spaced away from each other.

In some embodiments, the balancing vehicle may further comprise at least two first resilient members and at least two second resilient members.

In some embodiments, the at least two first resilient members may be located on each side of the first pivot axis and abutted against the first pedal and the first section such that the first pedal is parallel with the first section at idle.

In some embodiments, the at least two second resilient members may be located on each side of the second pivot axis and abutted against the second pedal and the second section such that the first pedal is parallel with the first section at idle.

In some embodiments, the first pivot axis and the second pivot axis are collinear. In some embodiments, the first pivot axis and the second pivot axis are not collinear.

In some embodiments, the base plate may include a third section connecting the first section and the second section.

In some embodiments, the third section may be higher than the first and second sections to form a support by itself.

In some embodiments, the resilient member may be a spring or a rubber block.

In some embodiments, the first, second, and third sections may be formed separately.

In some embodiments, either or both of the first and second detectors may include a gyroscope and an acceleration sensor.

In the third aspect, the present disclosure provides a balancing vehicle. The balancing vehicle comprises a baseplate, a first pedal, a second pedal, a first detector, a second detector, a first wheel, a second wheel, a first motor, a second motor, and a control system. The baseplate includes a first section and a second section. The first pedal is disposed above and pivotally connected to the first section. The second pedal is disposed above and pivotally connected to the second section. The first detector is attached to the first pedal to detect a motion status of the first pedal. The second detector is attached to the second pedal to detect a motion status of the second pedal. The first wheel is rotatably mounted to the first section. The second wheel is rotatably mounted to the second section. The first motor is disposed in and mechanically coupled to the first wheel to provide a driving force to the first wheel. The second motor is disposed in and mechanically coupled to the second wheel to provide a driving force to the second wheel. The control system attached to the baseplate and electronically connected to the first detector, the second detector, the first motor, and the second motor. The control system is configured to control the first motor and the second motor based on the motion status of the first pedal that is detected by the first detector and the motion status of the second pedal that is detected by the second detector.

In some embodiments, the balancing vehicle may further comprise a battery. The battery may be attached to the baseplate and electrically connected to the control system, the first detector, the second detector, the left motor, and the right motor to provide electricity to them.

In some embodiments, the balancing vehicle may further comprise at least two first resilient members and at least two second resilient members.

In some embodiments, the at least two first resilient members may be connected to the first pedal and the first section and located on each side of a first pivot axis about which the first pedal pivots such that the first pedal is parallel with the first section at idle.

In some embodiments, the at least two second resilient members may be connected to the second pedal and the second section and located on each side of a second pivot axis about which the second pedal pivots such that the second pedal is parallel with the second section at idle.

In some embodiments, the first section may be provided with two first supports upwardly protruded from the first section and spaced away from each other and second section may be provided with two second supports upwardly protruded from the second section and spaced away from each other.

In some embodiments, the first pedal may be pivotally connected to the two first supports, and the second pedal may be pivotally connected to the two second supports.

In some embodiments, either or both of the first and second detectors may include a gyroscope and an acceleration sensor.

In the balancing vehicle provided in the present disclosure, the left pedal and the right pedal are not connected with each other but are connected to the baseplate. The baseplate shares the weight of the human body and the load is distributed evenly such that structural damage of the balancing vehicle is reduced and the durability and lifetime can be improved. Therefore, this balancing vehicle has a good stability and is reliable and safe.

In the balancing vehicle provided in the present disclosure, the resilient members are provided between the pedal and the baseplate such that a buffer is provided after the user steps on the pedal. Therefore, the comfort level is improved.

In the balancing vehicle provided in the present disclosure, the motion statuses of the left and right pedals are respectively controlled by the left foot and the right foot. Particularly, each of the left and the right pedal is provided with a sensing system. Since the left and the right pedals are provided with independent sensing systems, the reaction of the balancing vehicle is more flexible and accurate, with reduced error. Moreover, the electric balancing vehicle with such structure does not need to be provided with a direction pole. Therefore, the practical and aesthetic functionality is improved.

### BRIEF DESCRIPTION OF THE DRAWINGS

The foregoing and other objects, features, and advantages of the application will be apparent from the following particular description of preferred embodiments of the present application, as illustrated in the accompanying drawings in which like reference characters refer to the same parts throughout the different views. The drawings are not necessarily to scale, and emphasis instead being placed upon illustrating the principles of the application.

FIG. 1 is a perspective view of a balancing vehicle according to a first embodiment of the present disclosure.

FIG. 2 is a front view of the balancing vehicle according to the first embodiment of the present disclosure.

FIG. 3 is a rear view of the balancing vehicle according to the first embodiment of the present disclosure.

FIG. 4 is a front view of the inner structure of the balancing vehicle according to the first embodiment of the present disclosure.

FIG. 5 is an exploded view of the balancing vehicle according to the first embodiment of the present disclosure.

FIG. 6 is another exploded view of the balancing vehicle according to the first embodiment of the present disclosure.

FIG. 7 is a left side view of the inner structure of the balancing vehicle according to the first embodiment of the present disclosure.

FIG. 8 is a right side view of the inner structure of the balancing vehicle according to the first embodiment of the present disclosure.

FIG. 9 is a top view of the inner structure of the balancing vehicle according to the first embodiment of the present disclosure.

FIG. 10 is an exploded view of the balancing vehicle according to a second embodiment of the present disclosure where the motors are located in the wheels.

FIG. 11 is an exploded view of the balancing vehicle according to a third embodiment of the present disclosure where the wheels are located under the baseplate.

FIG. 12 is a front view of the inner structure of the balancing vehicle according to a fourth embodiment of the present disclosure where there is only one wheel.

FIG. 13 illustrates different relationships between the supports and the pivot shaft.

FIG. 14 illustrates some embodiments in which the resilient members are disposed in different positions.

### DETAILED DESCRIPTION

Hereinafter, further detailed descriptions are made for the present disclosure through embodiments in conjunction with drawings.

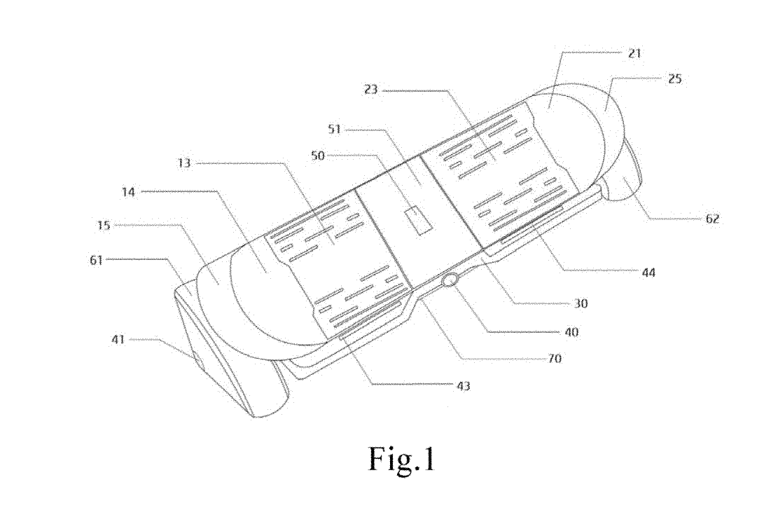

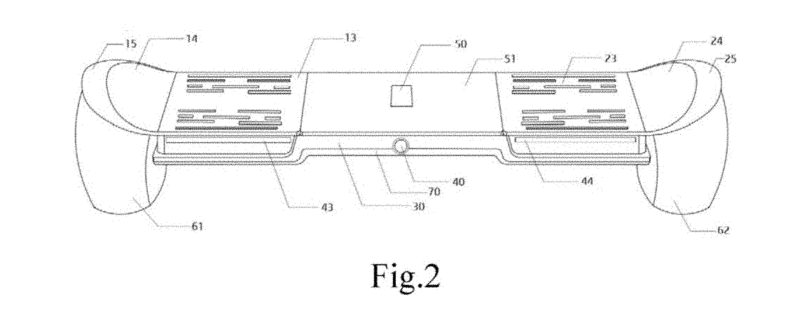

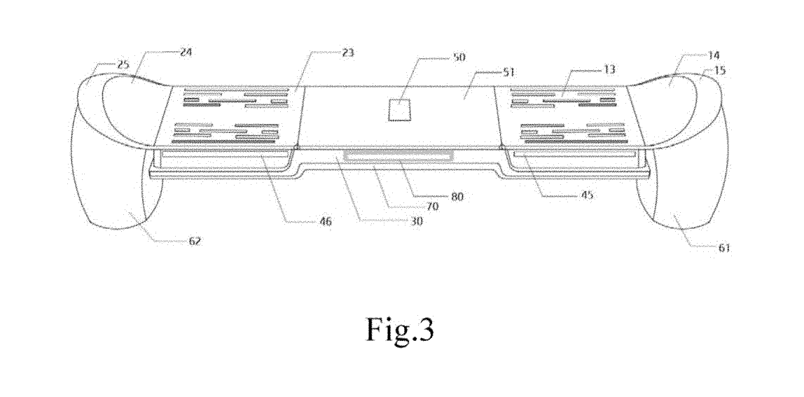

FIGS. 1-3 generally illustrate the external structure of the balancing vehicle according to the first embodiment of the present disclosure in different views. As shown in FIGS. 1-3, the balancing vehicle includes baseplate 30, left pedal cover 14, right pedal cover 24, container cover 51, bottom cover 70, left wheel 61, and right wheel 62.

Particularly, baseplate 30 forms a chassis of the vehicle and may be made of light and rigid material. Left pedal cover 14 and right pedal cover 24 are disposed on each side of baseplate 30 and cover a left pedal and a right pedal, respectively, which will be described in detail hereinafter. In order to keep safety when the vehicle is moving, left pedal cover 14 further comprises non-slip cushion 13 and wing 15 for preventing the user's foot from contacting wheel 61. Similarly, right pedal cover 24 further comprises non-slip cushion 23 and wing 25. Container cover 51 is disposed on baseplate 30 and between left pedal cover 14 and right pedal cover 24. Bottom cover 70 is attached to the baseplate from the bottom, for example, by using head screws.

LED screen 50 may be disposed on the top of the container cover or other appropriate positions to display some information, such as battery level, local time, and the like. As a result, the user can clearly know the power status of the balancing vehicle so as to avoid the situation in which the vehicle is stopped due to the lack of power.

In this embodiment, the balancing vehicle further includes left front light 43, right front light 44, left rear light 45, right rear light 46, left side light 41, a right side light (not shown), and middle logo light 40. These lights can improve the safety when the user is using the electric balancing vehicle at night.

In this embodiment, the balancing vehicle further includes handle 80 connected to the rear side of baseplate 30 in a rotatable manner.

In some embodiments, the balancing vehicle may also include an obstacle detector on the front to determine whether there is an obstacle on its travel route so as to a prevent the balancing vehicle and the rider from the collision. For example, the obstacle detector may be an ultrasonic, laser, or electro-optical distance detector.

In some embodiments, the balancing vehicle may comprise a speaker that is attached to the baseplate to play sound, such as FM broadcasting, audio alarm, honk, music, and so on.

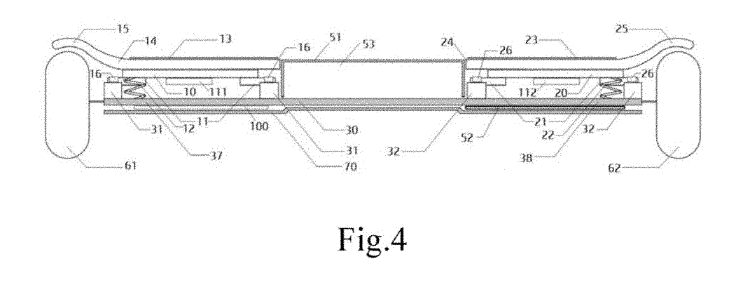

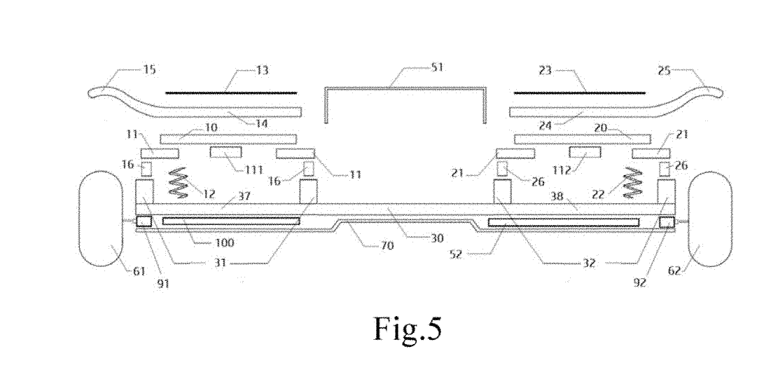

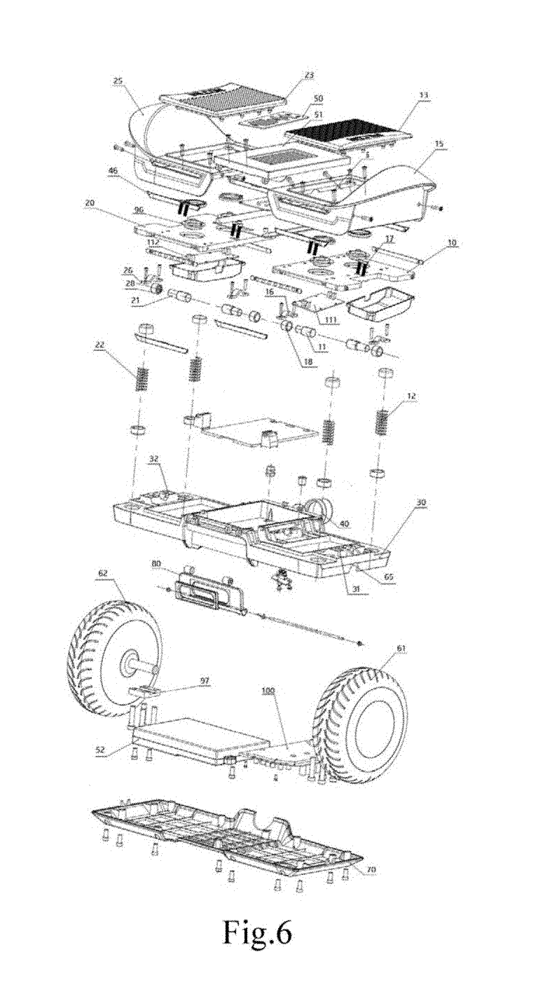

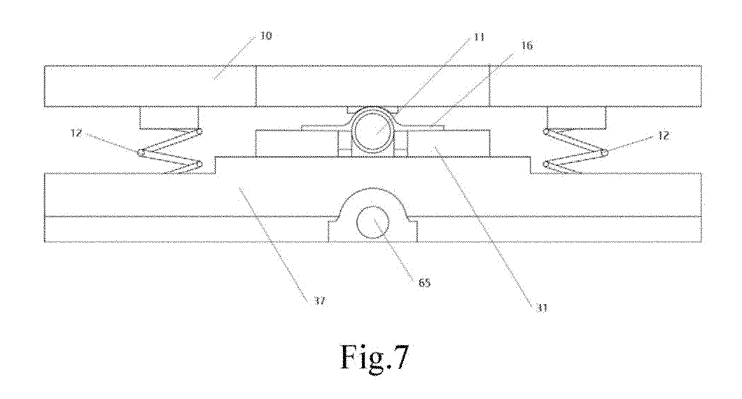

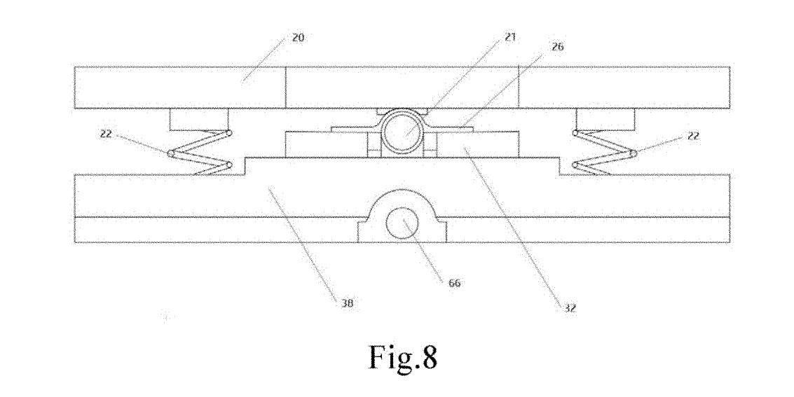

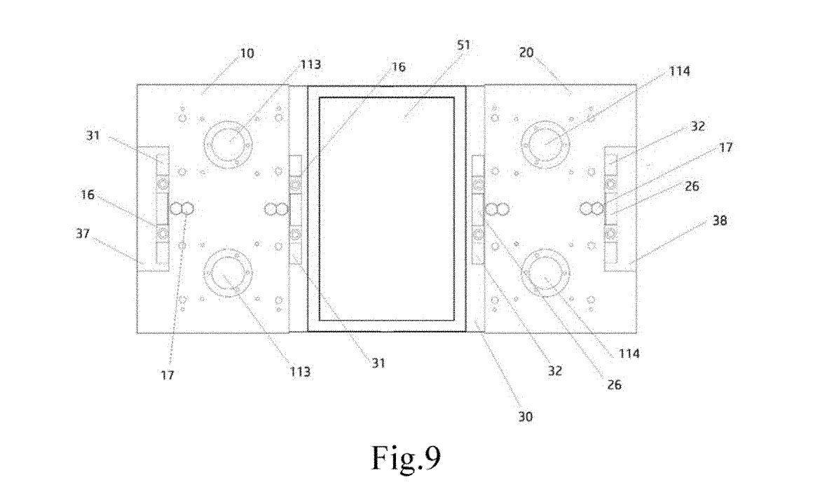

FIGS. 4-9 generally illustrate the inner structure of the balancing vehicle according to the first embodiment of the present disclosure. Particularly, FIG. 4 is a front view of the inner structure of the balancing vehicle. FIGS. 5-6 are exploded views of the balancing vehicle. FIGS. 7-8 are side views of the inner structure of the balancing vehicle. FIG. 9 is a top view of the inner structure of the balancing vehicle.

As shown in FIGS. 4-9, baseplate 30 is a flat rectangular piece and includes left section 37 and right section 38. On left section 37 is provided with two supports 31 spaced away from each other and each having a recess (see FIG. 6) to receive and support cylindrical shaft 11 therein. The two supports 31 extends upwards from left section 37. Two supports 31 are located in the middle of left section 37 along the width direction of baseplate 30.

As shown in FIG. 6, shaft 11 is inserted into bearing 18, which is received in the recess of supports 31 and fixed therein by Ω-shape fastener 16. Left pedal 10 is connected to shaft 11 with screws 17. Here, a two-screw connection is used to provide more stability. With such structure, left pedal 10 is able to rotate together with shaft 11 since the shaft 11 is rotatable in bearing 18. That is to say, left pedal 10 is inclinable relative to baseplate 30.

Similarly, two supports 32 extends upwards from the middle of right section 38 and each has a recess (see FIG. 6) for receiving a cylindrical shaft. As shown in FIG. 6, shaft 21 is inserted into bearing 28, which is received in the recess of supports 32 and fixed therein by Ω-shape fastener 26. Right pedal 20 is connected to shaft 21 with two screws 17. As a result, right pedal 10 is able to rotate together with shaft 21 since shaft 21 is rotatable in bearing 28. That is to say, right pedal 20 is inclinable relative to baseplate 30.

Those skilled in the art should understand that any methods for connecting the shaft to the pedal or to the support can be used as long as the pedal can pivot relative to the baseplate. For example, the shaft may be disposed in the recess without the bearing.

In the current embodiment, the balancing vehicle further comprises left detector 111 and right detector 112. Left detector 111 is attached to the bottom surface of left pedal 10 to detect a motion status of left pedal 10. Left detector 111 may include a gyroscope for detecting the rotational motion of left pedal 10 and an acceleration sensor for detecting the linear motion of left pedal 10.

Similarly, right detector 112 is attached to the bottom surface of right pedal 20 to detect its motion status. Right detector 112 may include a gyroscope for detecting the rotational motion of right pedal 20 and an acceleration sensor for detecting the linear motion of right pedal 20.

The gyroscope may be a vibrating gyroscope, a laser gyroscope, an MEMS gyroscope, and so on. The acceleration sensor may be a piezoelectric accelerometer, a piezoresistive accelerometer, and so on.

In use, the output signals of left and right detectors 111, 112 may be sent to a control system, which performs a predetermined algorithm or logic to determines the motion status of first and second pedals 10, 20 and will be described in detail hereinafter. Depending on the motion status, the control system could adjust the driving force output from left motor 91 or right motor 92 (see FIG. 5) to left wheel 61 or right wheel 62 so as to control the revolving speed of wheel 61 or 62.

In some embodiments, the detector may comprise two distance sensor attached to each side of the pedal or section along the width direction to detect the distance between the pedal and the section. Once the pedal inclines relative to the section, the distance between edges increases on one side and decreases on the other side. Therefore, the inclination status could be determined by these two distance sensors.

In some embodiments, the left and right pedals may be made of single piece and cannot rotate relative to each other, or they are fixed to the baseplate. In these scenarios, the user is still able to control each wheel separately by providing two pressure sensor on each pedal to detect the inclination of the user's body. Particularly, one pressure sensor is located near the user's toe, and the other near the heel. When the user inclines forward, the pressure detected near the toe will be larger than that detected near the heel, and vice versa. As a result, each wheel could be separately controlled by control system 100 by comparing these two pressure signals. In some embodiments, the pressure sensors may be used together with the gyroscope and the acceleration sensor to improve the accuracy. In some embodiments, the balancing vehicle may comprise a GPS.

In the current embodiment, the balancing vehicle further comprises two sensing switches 97 disposed in openings 113 (see FIG. 9) of left pedal 10, and two sensing switches 97 disposed in openings 114 (see FIG. 9) of right pedal 20. These sensing switches are used to enable the operation of the corresponding detectors. Actually, one sensing switch 97 on left pedal 10 and one sensing switch 97 on right pedal 20 are spare switches. Providing spare switches is convenient and practical because it avoids the defect that the balancing vehicle cannot start up when the only switch is broken.

In the current embodiment, the balancing vehicle further comprises left wheel 61 rotatably mounted to left section 37 and second wheel 62 rotatably mounted to right section 38.

As shown in FIG. 5, the balancing vehicle further comprises left motor 91 attached to left section 37 and mechanically coupled to left wheel 61 to output a driving force to left wheel 61. The balancing vehicle also comprises right motor 92 attached to the right section 38 and mechanically coupled to right wheel 62 to output a driving force to right wheel 62.

In some embodiments, both of left and right motors 91, 92 are electromotors that converts electrical energy to mechanical work. In some embodiments, both of left and right motors 91, 92 are engines that converts thermal energy to mechanical work. In some embodiments, there may be transmission or differential mechanism coupled between the output shaft of the motor and the shaft of the wheel.

In the current embodiment, the balancing vehicle further comprises battery 52 attached to baseplate 30 and electrically connected to left detector 111, right detector 112, left motor 91, and right motor 92 for power supply. In this embodiment, battery 52 is a storage battery pack. In some embodiments, the vehicle may comprise a photovoltaic module and battery 52 is a solar cell. In some embodiments, the balancing vehicle may comprise a USB charging port through which battery 52 can be charged or discharged.

Those skilled in the art should understand that battery 52 may be located at any suitable position in the balancing vehicle. For example, battery 52 may be located above baseplate 30, or there may be two or more batteries disposed on each side of baseplate 30 and electrically connected in series.

In the current embodiment, the balancing vehicle further comprises control system 100 attached to baseplate 30, electrically connected to battery 52, and electronically connected to left detector 111, right detector 112, left motor 91, and right motor 92, for example, through a bus (now shown). Control system 100 may also be in wireless connection with left detector 111, right detector 112, left motor 91, and right motor 92 to save space. Control system 100 may further comprise a communication module through which it can exchange information with external sources, for example, via Bluetooth, IR, WIFI, and so on. Those skilled in the art should understand that control system 100 may be disposed at any suitable position in the balancing vehicle. For example, it may be a whole PCB disposed above baseplate 30, or it may be two or more separated circuits distributed throughout baseplate 30.

In some embodiments, control system 100 may comprise a processor or a programmable logic circuit which is configured to control the revolving speed of left motor 91 and right motor 92 based on the motion status of the left pedal 10 that is detected by left detector 111 and the motion status of right pedal 20 that is detected by right detector 112.

Particularly, during the operation of the electric balancing vehicle, when the user's left foot steps on left pedal 10, sensing switch 96 is touched and turned on. Similarly, sensing switch 96 on right pedal 20 is touched and turned on when the user's right foot steps on right pedal 20. Once the user's left foot presses the front or rear part of left pedal 10, left pedal 10 inclines forwards or backwards. At this time, left detector 1 attached to the bottom of left pedal 10 inclines forwards or backwards along with left pedal 10. Meanwhile, left detector 111 detects the motion status of left pedal 10 and transmits the signal to control system 100. Then control system 100 sends a signal to left motor 91 to adjust its output driving force so as to control the revolving speed of left wheel 61. For example, if left pedal 10 is detected to incline forward, control system 100 may increase the output power of left motor 91, for example, by increase the input power of left motor 91. This can be achieved by performing Pulse Width Modulation (PWM) on the output power from battery 52 to left motor 91. When the user steps hard on left pedal 10 and right pedal 20 simultaneously to the forward, left wheel 61 and right wheel 62 keep rolling forwards, and the balancing vehicle moves forwards. When the user steps hard on left pedal 10 and right pedal 20 backwards simultaneously, left wheel 61 and right wheel 62 keep rolling backwards, and the balancing vehicle moves backwards. However, when the stepping motion of the user makes motion statuses of left pedal 10 and right pedal 20 inconsistent, the balancing vehicle will turn. Meanwhile, left detector 111 and right detector 112 will feed back the swing magnitude of the user's body, such that left motor 91 and right motor 92 obtain different power outputs, so as to adjust the velocity of the balancing vehicle.

In some embodiments, control system 100 may comprise a left controller to control left wheel 61 and a right controller to control right wheel 62. The left controller may be electronically connected to left detector 111 and left motor 91. For example, the output terminals of the gyroscope and the acceleration sensor may be connected to the input terminals of the left controller. Similarly, the right controller may be electronically connected to left detector 112 and right motor 92. During operation, when left detector 111 detects the motion status of left pedal 10, it transmits a signal indicating the status to the left controller. Then the left controller sends a signal to left motor 91 to adjust its output driving force so as to control the revolving speed of left wheel 61. For example, if left pedal 10 is detected to incline forward, the left controller may increase the output power of left motor 91, for example, by increase the input power of left motor 91. This can be achieved by performing Pulse Width Modulation (PWM) on the output power from battery 52 to left motor 91. Similarity, when right detector 112 detects the motion status of left pedal 20, it transmits a signal indicating the status to the right controller. Then the right controller sends a signal to right motor 92 to adjust its output driving force so as to control the revolving speed of right wheel 62. For example, if right pedal 20 is detected to incline backward, the right controller may decrease the output power of right motor 92, for example, by decrease the input power of right motor 92. This can be achieved by performing Pulse Width Modulation (PWM) on the output power from battery 52 to right motor 92.

In some embodiments, there may be a left battery providing electricity to left motor 91, the left controller, and left detector 111, and a right battery providing electricity to right motor 92, the right controller, and right detector 112.

In the current embodiment, the balancing vehicle further comprises two left resilient members 12 connected to left pedal 10 and left section 37 and located on each side of a left axis about which left pedal 10 pivots or rotates. In some embodiments, the number of left resilient members 12 may be more than two. For example, two resilient members may be located on the left of the left axis and one on the right, as long as left pedal 10 could keep parallel with left section 37 at idle.

The balancing vehicle further comprises two right resilient members 22 connected to right pedal 20 and right section 38 and located on each side of a right axis about which right pedal 20 pivots or rotates. In some embodiments, the number of right resilient members 22 may be more than two. For example, two resilient members may be located on the left of the right axis and three on the right, as long as right pedal 20 could keep parallel with right section 38 at idle. In some embodiments, the left axis and the right axis are collinear. In some embodiments, the left axis and the right axis are not collinear.

The resilient member may be a spring abutted against the pedal and the section, for example, through a silicone cap. In some embodiments, the resilient member may be any elastic parts such as foam, rubber, and so on. The resilient member makes the user get a certain buffer after stepping on the pedal, so as to improve the comfort level. In some embodiments, a magnetic repulsive force may be used to replace the resilience.

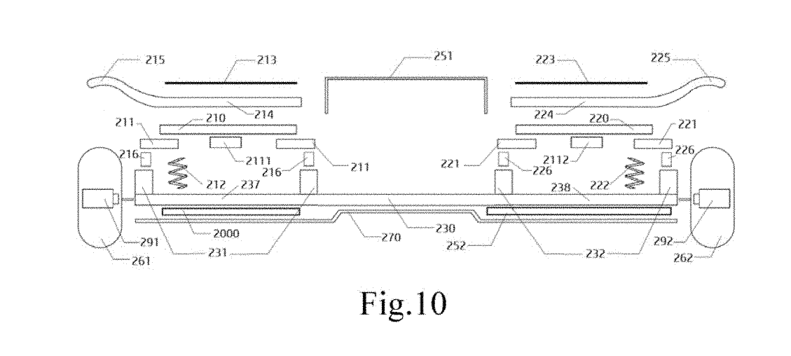

FIG. 10 is an exploded view of the balancing vehicle according to a second embodiment of the present disclosure. In this embodiment, left motor 291 and right motor 292 are disposed in left wheel 261 and right wheel 262, respectively. Since this embodiment is very similar to the first embodiment, the detailed description of this embodiment will be omitted.

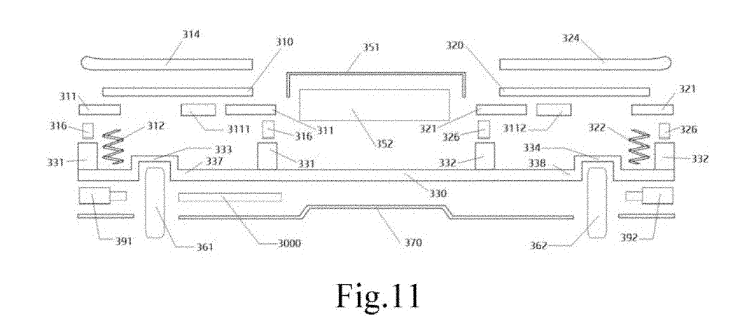

FIG. 11 is an exploded view of the balancing vehicle according to a third embodiment of the present disclosure. In this embodiment, left wheel 361 and right wheel 362 are located under baseplate 330, and battery 352 is located above baseplate 330. Since the other components in this embodiment are similar to those in the first and second embodiments, the detailed description of this embodiment will be omitted.

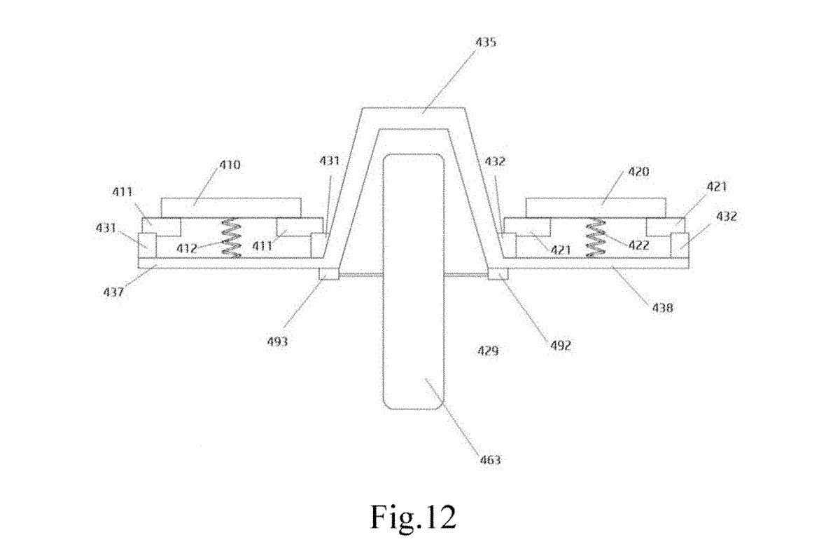

FIG. 12 is a front view of the inner structure of the balancing vehicle according to a fourth embodiment of the present disclosure. In this embodiment, there is only one wheel 463 accommodated in recess 435. In this embodiment, the balancing vehicle may comprise a steering mechanism. Since the other components in this embodiment are similar to those in the other embodiments, the detailed description of this embodiment will be omitted.

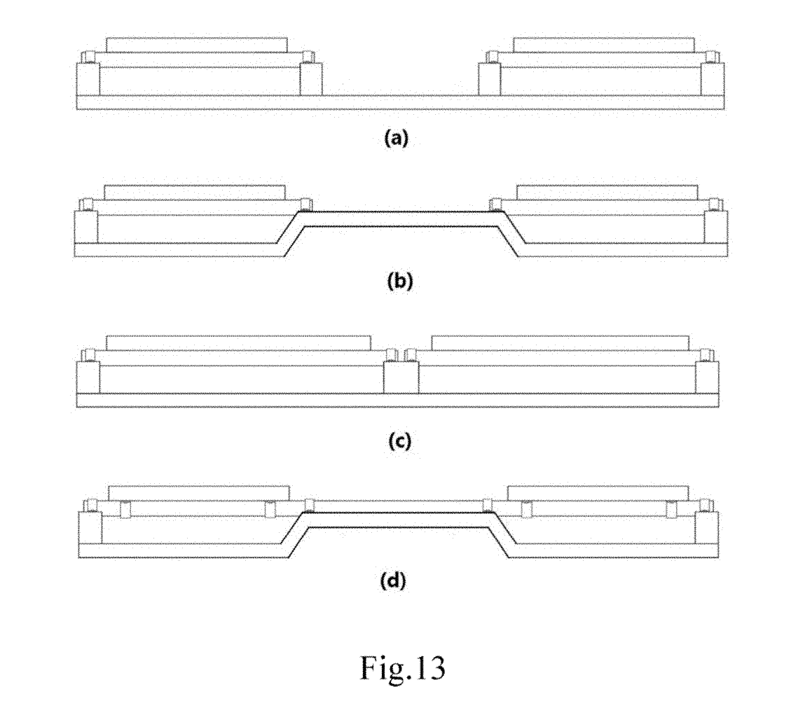

FIG. 13 illustrates different relationships between the supports and the pivot shaft. In FIG. 13(a), each of the left and right pedals is pivotally connected to two supports through one cylindrical shaft. In FIG. 13(b), the middle section between the left and right sections arches to function as a support such that each of the left and right pedals is pivotally connected to a support and the middle section. In FIG. 13(c), there are three supports, and the middle one is used to support both the left shaft and the right shaft. In FIG. 13(d), both the left and right pedals are connected to the supports through one single shaft. In order to realize a relative motion between the left pedal and the right pedal, the left pedal and the right pedal are no longer fixed to the shaft but are able to rotate relative to the shaft.

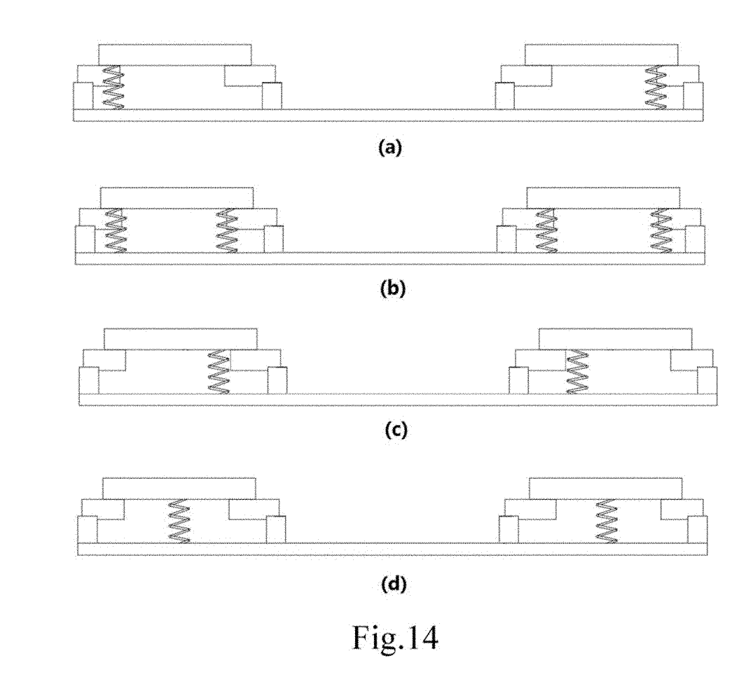

FIG. 14 illustrates some embodiments in which the resilient members are disposed in different positions. In FIG. 14(a), the resilient members are located near the outer side of the baseplate. In FIG. 14(b), there are four resilient members on each of the left and right sections. These resilient members are located at four corners of the pedals. In FIG. 14(c), the resilient members are located away from the outer side of the baseplate. In FIG. 14(d), the resilient members are located in the middle of each of the left and right sections.

The two-pedal connection mechanism described in the present disclosure not only can be used in a double-wheeled balancing vehicle, but also can be used in a three-wheeled balancing vehicle, a four-wheeled balancing vehicle, or other suitable types of vehicles.

For a person with ordinary skill in the art, other kinds of corresponding alternations and modifications can be made according to technical solutions and concepts described above. All of these alternations and modifications should belong to the scope of the claims of the present disclosure

What is claimed is:

1. A balancing vehicle, comprising:
a baseplate;
a pedal assembly disposed above and pivotally connected to the baseplate;
a detecting module attached to the pedal assembly to detect motion status of the pedal assembly;
a wheel assembly rotatably connected to the baseplate; and
a control system attached to the baseplate, wherein the control system is electronically connected to the detecting module and mechanically coupled to the wheel assembly so as to control the wheel assembly based on the motion status of the pedal assembly detected by the detecting module.

2. The balancing vehicle according to claim 1, wherein the baseplate includes a first section, a second section opposite to the first section, and wherein the baseplate includes at least two first supports on the first section and at least two second supports on the second section.

3. The balancing vehicle according to claim 2, wherein the pedal assembly includes:
a first pedal pivotally connected to the at least two first supports, and
a second pedal pivotally connected to the at least two second supports.

4. The balancing vehicle according to claim 1, wherein the baseplate includes a first section, a second section opposite to the first section, and a third section between the first section and the second section, and wherein the baseplate includes a first supports on the first section, a second supports on the second section, and a third support on the third section.

5. The balancing vehicle according to claim 4, wherein the pedal assembly includes:
a first pedal pivotally connected to the first support and the third support, and
a second pedal pivotally connected to the second support and the third support.

6. The balancing vehicle according to claim 4, further comprising:
at least two first resilient members abutted against the first pedal and the first section therebetween and located on each side of a first pivot axis about which the first pedal pivots, and
at least two second resilient members abutted against the second pedal and the second section therebetween and located on each side of a second pivot axis about which the second pedal pivots.

7. The balancing vehicle according to claim 3, wherein the detecting module comprises:
a first detector disposed between the first pedal and the first section to detect a motion of the first pedal relative to the first section, and
a second detector disposed between the second pedal and the second section to detect a motion of the second pedal relative to the second section.

8. The balancing vehicle according to claim 7, wherein the first detector comprises a gyroscope and an acceleration sensor.

9. The balancing vehicle according to claim 1, wherein the control system includes:
a motor attached to the baseplate and mechanically coupled to the wheel assembly to output a driving force thereto,
a controller attached to the baseplate and electronically connected to the detecting module and the motor to control the driving force output by the motor based on the motion status of the pedal assembly detected by the detecting module, and
a battery attached to the baseplate and electrically connected to the motor, the detecting module, and the controller.

10. A balancing vehicle, comprising:
a baseplate including a first section and a second section opposite to the first section;
a first pedal disposed above and pivotally connected to the first section;
a second pedal disposed above and pivotally connected to the second section;
a first detector attached to the first pedal to detect a motion status of the first pedal;
a second detector attached to the second pedal to detect a motion status of the second pedal;
a first wheel rotatably mounted to the first section;
a second wheel rotatably mounted to the second section;
a first motor attached to the first section and mechanically coupled to the first wheel to output a driving force to the first wheel;
a second motor attached to the second section and mechanically coupled to the second wheel to output a driving force to the second wheel; and
a control system attached to the baseplate and electronically connected to the first detector, the second detector, the first motor, and the second motor, wherein the control system is configured to control the first motor and the second motor based on the motion status of the first pedal that is detected by the first detector and the motion status of the second pedal that is detected by the second detector.

11. The balancing vehicle according to claim 10, further comprising a battery attached to the baseplate and electrically connected to the control system, the first detector, the second detector, the first motor, and the second motor.

12. The balancing vehicle according to claim 10, wherein the first section is provided with at least two first supports protruded from the first section and spaced away from each other, and the second section is provided with at least two second supports protruded from the second section and spaced away from each other.

13. The balancing vehicle according to claim 12, wherein the first pedal pivotally connected to the at least two first supports such that the first pedal is pivotable about a first pivot axis, and the second pedal pivotally connected to the at least two second supports such that the second pedal is pivotable about a second pivot axis.

14. The balancing vehicle according to claim 13, further comprising:
at least two first resilient members located on each side of the first pivot axis and each abutted against the first pedal and the first section, and
at least two second resilient members located on each side of the second pivot axis and each abutted against the second pedal and the second section.

15. The balancing vehicle according to claim 10, wherein the first detector comprises a gyroscope and an acceleration sensor.

16. A balancing vehicle, comprising:
a baseplate including a first section and a second section;
a first pedal disposed above and pivotally connected to the first section;
a second pedal disposed above and pivotally connected to the second section;
a first detector attached to the first pedal to detect a motion status of the first pedal;
a second detector attached to the second pedal to detect a motion status of the second pedal;
a first wheel rotatably mounted to the first section;
a second wheel rotatably mounted to the second section;
a first motor disposed in and mechanically coupled to the first wheel to provide a driving force to the first wheel;
a second motor disposed in and mechanically coupled to the second wheel to provide a driving force to the second wheel; and
a control system attached to the baseplate and electronically connected to the first detector, the second detector, the first motor, and the second motor, wherein the control system is configured to control the first motor and the second motor based on the motion status of the first pedal that is detected by the first detector and the motion status of the second pedal that is detected by the second detector.

17. The balancing vehicle according to claim 16, further comprising a battery attached to the baseplate and electrically connected to the control system, the first detector, the second detector, the first motor, and the second motor.

18. The balancing vehicle according to claim 16, further comprising:
at least two first resilient members connected to the first pedal and the first section and located on each side of a first pivot axis about which the first pedal pivots, and
at least two second resilient members connected to the second pedal and the second section and located on each side of a second pivot axis about which the second pedal pivots.

19. The balancing vehicle according to claim 16, wherein the first section is provided with at least two first supports protruded from the first section and spaced away from each other and second section is provided with at least two second supports protruded from the second section and spaced away from each other.

20. The balancing vehicle according to claim 19, wherein the first pedal is pivotally connected to the at least two first supports, and the second pedal is pivotally connected to the at least two second supports.
